(19) United States
(12) Patent Application Publication
(10) Pub. No.: US 2025/0252719 A1
(43) Pub. Date: Aug. 7, 2025

(54) SYSTEM AND A METHOD FOR IMPROVING NEURAL NETWORK TRAINING IN OBJECT PROCESSING

(71) Applicant: INDUSTRIES MACHINEX INC., Plessisville (CA)

(72) Inventors: Dominic DUCHESNE, Drummondville (CA); Joel CHAMPOUX, Victoriaville (CA); Jean-Michel PARE, Plessisville (CA)

(21) Appl. No.: 19/181,955

(22) Filed: Apr. 17, 2025

Related U.S. Application Data
(60) Provisional application No. 63/635,778, filed on Apr. 18, 2024.
(60) Provisional application No. 63/635,779, filed on Apr. 18, 2024.

(30) Foreign Application Priority Data
Apr. 17, 2025 (WO) PCT/CA2025/050567

(51) Int. Cl. G06V 10/778; G06V 10/26; G06V 10/764; G06V 10/82

(52) U.S. Cl. CPC G06V 10/7784; G06V 10/26; G06V 10/764; G06V 10/82

(57) ABSTRACT

A method and a system for improving neural network training in object processing. The method comprises: receiving, from an object classification process using scene images of objects in an object processing facility, a set of segmented and classified objects captured during a pre-determined period; grouping the object images of the segmented and classified objects by a grouping routine based on their visual likeness to generate grouped object images, the grouping routine comprising at least one neural network; evaluating the objects of the object images based on comparison scores by a comparison routine, and generating a plurality of object sequences; and executing, by an automated learning routine, unsupervised and semi-supervised learning tasks by using the plurality of object sequences.

### RELATED APPLICATION

The present application claims priority to or benefit of U.S. provisional patent application No. 63/635,779, filed Apr. 18, 2024, U.S. provisional patent application No. 63/635,778, filed Apr. 18, 2024, and PCT patent application PCT/CA2025/050567 “A System and a Method for Detection and Recognition of Materials”, filed on Apr. 17, 2025, which are incorporated herein by reference in their entirety.

### TECHNICAL FIELD

The present disclosure relates to systems and methods for object processing. More specifically, it relates to neural network training in object processing.

### BACKGROUND

Various systems exist for object processing. For example, sorting systems may be important in various industries, including, but not limited to, the recycling industry. Proper recognition of the objects being recycled is the major task of sorting.

Currently known systems and methods for automatic and continuous detection of the materials and recognition of the objects still need to be improved, by increasing not only the speed but also the quality and the cost of such detection and recognition.

### SUMMARY

A method and a system for improving neural network training in object processing are herein provided. The method and the system may also help to improve precision in detection and classification of material of objects.

According to one aspect of the disclosed technology, there is provided a method comprising: receiving, from an object classification process using scene images of objects in an object processing facility, a set of segmented and classified objects captured during a pre-determined period; grouping the object images of the segmented and classified objects by a grouping routine based on their visual likeness to generate grouped object images, the grouping routine comprising at least one neural network; evaluating the objects of the object images based on comparison scores by a comparison routine, and generating a plurality of object sequences; and executing, by an automated learning routine, unsupervised and semi-supervised learning tasks by using the plurality of object sequences to generate a final result.

According to another aspect of the disclosed technology, there is provided a system comprising: a camera configured to capture initial object images of objects; a display; and a processor configured to: receive, from an object classification process using scene images of objects in an object processing facility, a set of segmented and classified objects captured during a pre-determined period; group the object images of the segmented and classified objects by a grouping routine based on their visual likeness to generate grouped object images, the grouping routine comprising at least one neural network; evaluate the objects of the object images based on comparison scores by a comparison routine, and generating a plurality of object sequences; and execute, by an automated learning routine, unsupervised and semi-supervised learning tasks by using the plurality of object sequences to generate a final result.

In at least one embodiment, prior to executing the automated learning routine, the method comprises adapting the plurality of object sequences to new target environments using a data adaptation routine to generate adapted object sequences and using the plurality of adapted object sequences by the automated learning routine when executing the unsupervised and the semi-supervised learning tasks. The data adaptation routine may be executed by entropy minimization, contrastive learning for Test Time Adaptation (TTA), batch normalization adaptation, adaptive data augmentation, or a transfer learning and fine tuning.

The at least one neural network may be a convolutional neural network (CNN) having at least two convolutional layers, a vision transformer based (ViT-based) model, a multi layer perceptron based (MLP-based) model, or a hybrid model comprising at least two of: elements of the CNN model, elements of the ViT-based model, and elements of the MLP-based model. The at least one neural network may be a convolutional neural network (CNN) having at least two convolutional layers, a vision transformer-based (ViT-based) model, a multilayer perceptron-based (MLP-based) model, a autoencoder-based model, a contrastive learning model, a generative model, or a hybrid model comprising at least two of: elements of the CNN model, elements of the ViT-based model, elements of the MLP-based model, elements of the autoencoder-based model, elements of the contrastive learning model, and elements of the generative model. The method may further comprise identifying objects of interest when comparing against pre-annotated objects after generating the plurality of object sequences. The method may further comprise learning the object classification process using the final results to modify neural networks of the object classification process. The method may further comprise generating at least one new neural network, which may be used, for example, in the object classification routine or later by other routines of the method.

In at least one embodiment, each one of the object classification routine, the grouping routine, the comparison routine, the data adaptation routine, and the automated learning routine may be executed using models having different architectures, each model having at least one neural network being a convolutional neural network (CNN) having at least two convolutional layers, a vision transformer-based (ViT-based) model, a multilayer perceptron-based (MLP-based) model, a autoencoder-based model, a contrastive learning model, a generative model, or a hybrid model comprising at least two of: elements of the CNN model, elements of the VIT-based model, elements of the MLP-based model, elements of the autoencoder-based model, elements of the contrastive learning model, and elements of the generative model.

Sensor data may be captured and generated at the time of acquisition (capturing) of the scene images, the sensor data may be received from at least one additional sensor and used as input to the object classification process. The system may further comprise at least one sensor (additional sensor) generating sensor data at the time of acquisition of the object images, the sensor data being used as input for the object classification process. The at least one additional sensor may be at least one of a laser sensor, a volumetric sensor, a point measurement system for visible spectroscopy, a near infrared (NIR) system, a short-wave infrared (SWIR) system, a middle wavelength infrared (MWIR) system, a radiography or fluoroscopy X-ray system, a thermal camera, a visible detector, and an invisible detector. The at least one additional sensor may comprise a near infrared (NIR) system and a short-wave infrared (SWIR) system. The scene images may be captured by a camera which is an RGB camera or a grayscale camera. The scene images may be captured by a camera operating on a line-scan or area-scan basis.

The processor may be further configured to identify objects of interest when comparing against pre-annotated objects. The processor may be further configured to, prior to executing the automated learning routine, adapt the plurality of object sequences to new target environments using a data adaptation routine to generate adapted object sequences and use the plurality of adapted object sequences by the automated learning routine when executing unsupervised and semi-supervised learning tasks. The processor may be configured, by the automated learning routine, to modify neural networks of the object classification process.

A method and a system for improving neural network training in object processing are provided herein. In at least one embodiment, the method comprises: receiving, from an object classification process using scene images of objects in an object processing facility, a set of segmented and classified objects captured during a pre-determined period; grouping the object images of the segmented and classified objects by a grouping routine based on their visual likeness to generate grouped object images, the grouping routine comprising at least one neural network; evaluating the objects of the object images based on comparison scores by a comparison routine, and generating a plurality of object sequences; and executing, by an automated learning routine, unsupervised and semi-supervised learning tasks by using the plurality of object sequences.

According to another aspect of the disclosed technology, there is provided a method comprising: automatically assessing, by a performance evaluation routine, a real-time effectiveness of an object classification process deployed in a sorting facility; grouping of object images by a grouping routine which comprises at least one convolutional neural network (CNN) having at least two convolutional layers, the object images having been generated by the object classification process using a camera, based on their visual likeness; evaluating the objects based on comparison scores by a comparison routine, and generating a plurality of object sequences, and optionally identifying objects of interest when comparing against pre-annotated objects; and conducting, by an automated learning routine, unsupervised and semi-supervised learning tasks by using the plurality of object sequences generated by the comparison routine. In at least one embodiment, the method comprises using neural networks, such as, for example, convolutional neural networks (CNN) having at least two convolutional layers, to generate a set of segmented and classified objects captured during a pre-determined period by an object classification process; and grouping the objects, by a grouping routine comprising at least one other CNN having at least two other convolutional layers, to generate a plurality of object sequences based on comparison scores with regards to pre-annotated objects to determine objects of interest for at least one of unsupervised learning and semi-supervised learning.

The object images may also comprise sensor data from a laser sensor, captured at the time of acquisition of the object images, which serves as input for the routines. The object images may also comprise sensor data from a volumetric sensor, captured at the time of acquisition, which serves as input for the routines. The object images may also comprise an output of a point measurement system for visible spectroscopy values, captured at the time of acquisition, which serves as input for the routines. The object images may also comprise sensor data generated by at least one of: a near infrared (NIR) system, a short-wave infrared (SWIR) system, a middle wavelength infrared (MWIR) system, the sensor data being captured at the time of acquisition, which serves as input for the routines. The object images may also comprise sensor data generated by and received from a radiography or fluoroscopy X-ray system, captured at the time of acquisition, which serves as input for the routines.

The object images may also comprise sensor data generated by and received from a thermal camera, captured at the time of acquisition, which serves as input for the routines. The object images may also comprise sensor data generated by and received from a visible detector, captured at the time of acquisition, which serves as input for the routines. The object images may also comprise sensor data generated by and received from an invisible marker detector, captured at the time of acquisition, which serves as input for the routines. The camera may be an RGB or grayscale camera. The camera may operate on a line-scan or area-scan basis.

### BRIEF DESCRIPTION OF THE DRAWINGS

Further features and advantages of the present disclosure will become apparent from the following detailed description, taken in combination with the appended drawings, in which:

FIG. 1 is a schematic block diagram of a system for improving neural network training in object processing, in accordance with at least one embodiment of the present disclosure;

FIG. 2 illustrates a flow diagram of a method for improving neural network training in object processing, in accordance with at least one embodiment of the present disclosure;

FIG. 3 illustrates a flow diagram of a method for improving neural network training in object processing using output of any object classification process, in accordance with at least one embodiment of the present disclosure;

FIG. 4 illustrates non-limiting examples of grouped object images, in accordance with at least one embodiment of the present disclosure;

FIGS. 5 and 6 illustrate non-limiting examples of poorly characterized objects in supervised-review images, in accordance with at least one embodiment of the present disclosure; and

FIG. 7 non-limiting example image with unmatched objects, in accordance with at least one embodiment of the present disclosure.

It will be noted that throughout the appended drawings, like features are identified by like reference numerals.

### DETAILED DESCRIPTION

Various aspects of the present disclosure generally address one or more of the problems of object processing. The object processing may comprise detecting the material, such as, for example, recycled or recyclable material or construction material, such as, for example, plastics, paper, metal, etc. The present description provides a system and a method for improving neural networks training in object processing. The system and the method as described herein may help to improve the precision in detection and classification of materials that various objects are made of. The system and the method as described herein use a similarity-based machine learning workflow to train a material computer vision system. The system and method as described herein also classifies and groups the materials, and helps to group corresponding objects to facilitate sorting. The system and method as described herein may be used for sorting objects made of various materials. For example, the system and method as described herein may be used for sorting objects made of recycled or recyclable material or construction materials, such as, for example, plastics, paper, etc.

The present technology is configured to determine detection and/or classification performance metrics, execute machine learning on its own or semi-supervised. The sorting equipment as described herein is configured to improve continuous sorting with minimal internal costs and more efficiently. The technology permits to significantly improve the sorting over time.

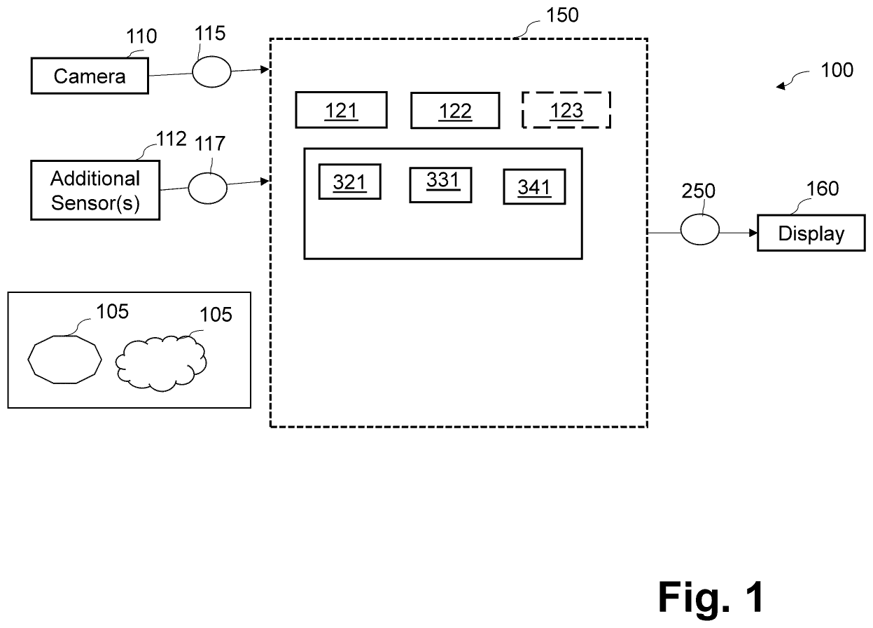

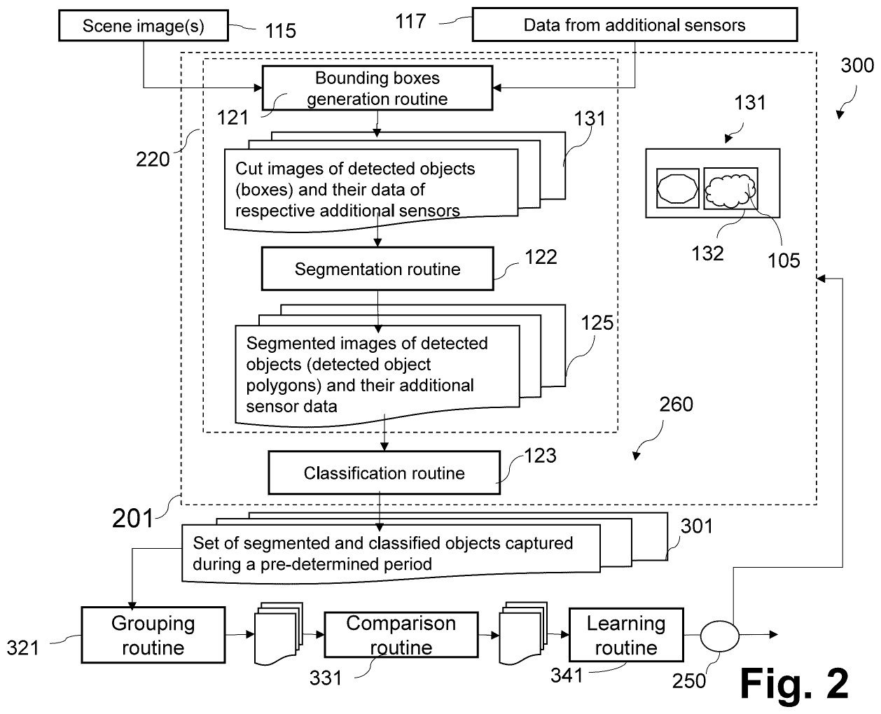

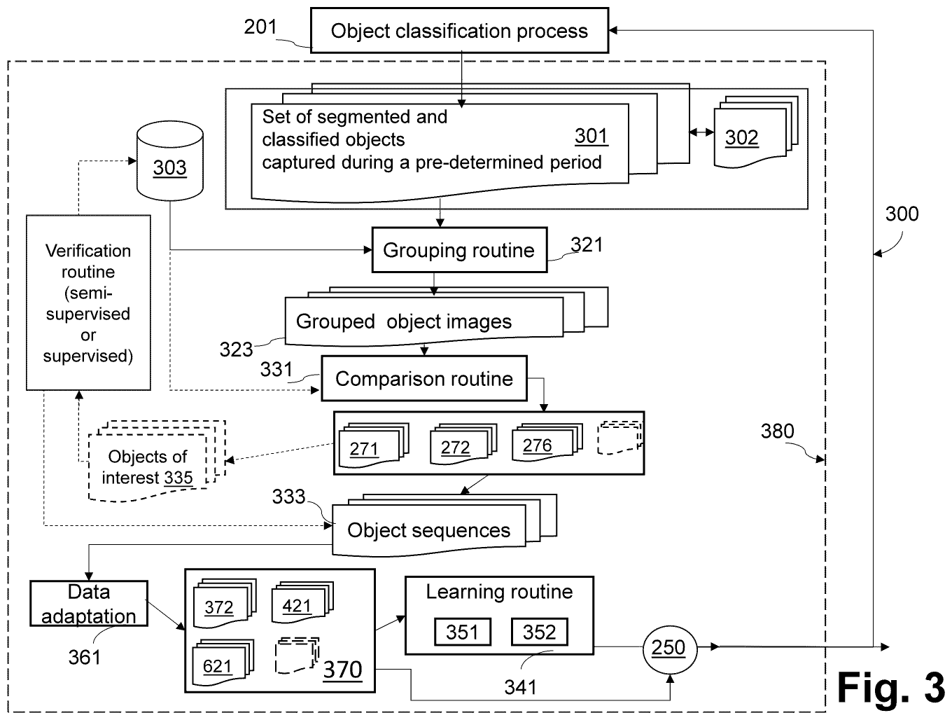

FIG. 1 is a schematic block diagram of a system 100 for executing methods 200, 300 for improving the precision in detection and classification of objects 105 that are being recycled, in accordance with at least one embodiment of the present disclosure. FIG. 2 illustrates the execution steps (in other words, a flow diagram) of method 200 for improving the precision in detection and classification of objects 105, in accordance with at least one embodiment of the present disclosure. FIG. 3 illustrates the execution steps (in other words, a flow diagram) of method 300 for improving the precision in detection and classification of objects 105 where the object classification process may be an object classification process 201 illustrated in FIG. 2 or any other, in accordance with at least one embodiment of the present disclosure. When discussing the system 100 and the methods 200, 300 herein below, reference will be made to FIGS. 1, 2, and 3.

The system 100 comprises at least one camera 110. In at least one embodiment, the camera 110 may be an RGB (red, green, blue) camera and/or a grayscale camera. For example, more than one camera 110 may comprise one or more RGB camera, one or more greyscale camera, or both RBG camera(s) and greyscale camera(s). The camera(s) 110 are configured to capture scene images 115, which may be RGB image(s) and/or grayscale image(s), respectively, obtained by the RGB camera(s) and/or the grayscale camera(s). The one or more camera 110 may be configured to operate on a line-scan or area-scan basis to cover blind spots. In at least one embodiment, the images are then stored in the cloud and/or in a data center (which may be cloud-based or local).

The system 100 may also have at least one additional sensor 112. In addition to the scene images 115, additional sensor data 117 may be generated by the additional sensors 112 (also referred to herein as “additional devices 112”). In the technology as described herein, various additional sensors 112 are configured to obtain and generate the additional sensor data 117 (which may be also referred to herein as the “complimentary data 117” or the “input sensor data” or the “sensor data”). The additional sensors 112 may be one or more of the following: a laser sensor, a volumetric sensor, an electromagnetic detector, a point measurement system for visible spectroscopy, a near-infrared (NIR) system, a NIR spectroscopy point measurement system (point measurement system for visible spectroscopy values), a short-wave infrared (SWIR) system, a middle wavelength Infrared (MWIR) system, a sensor for measuring X-rays, a sensor for measuring X-ray fluorescence (fluoroscopy X-ray system), a thermal camera, a visible marker detector, an invisible marker detector. In at least one embodiment, the laser sensor is configured to determine the height and/or presence of items. Preferably, the additional sensors 112 are the NIR system and the SWIR system, or at least the additional sensors 112 comprise such two systems. In some embodiments, the system 100 does not have the additional sensors 112.

Still referring to FIG. 1, in at least one embodiment, the system 100 comprises a processor 150 and a non-transitory computer readable medium with computer executable instructions stored thereon. In some embodiments, the processor 150, a memory, and the non-transitory computer readable medium are located on a server. The processor 150 as described herein is configured to execute an application which executes or otherwise has access to routines as described herein. The camera 110 and the additional sensors 112 may communicate with the server 150 via a network (for example, a wireless or a wired network). In some other embodiments, the memory, the processor 150 and the non-transitory computer readable medium are located in an electronic device. For example, the electronic device may be a computer, an iPad, a phone, etc. In at least one embodiment, the electronic device may also comprise a screen (which may be the same or different from display 160 of FIG. 1) for displaying a final result 250, generated by the processor 150.

The “routines” as referred to herein are each configured to execute a series of specific tasks and functions by executing steps as described herein. In at least one embodiment, each corresponding module implements its corresponding routine in software and hardware.

Referring also to FIG. 1, the system 100 comprises modules 121, 122, 123. In at least one embodiment, each module 121, 122, 123 has and uses at least one neural network for execution of routines described herein. In at least one embodiment, the at least one neural network for execution of each routine described herein may be a convolutional neural network (also referred to as a “convolutional layer deep learning network” or “CNN”) having at least two convolutional layers, a vision-transformer-based model (also referred to as the “ViT-based model” or “ViT-based routine”), a multilayer perceptron-based model (also referred to as “MLP-based model” or “MLP-based routine”), and a hybrid model described below.

In at least one embodiment, the neural network may be at least one CNN which is configured to extract characteristics of the objects 105. In at least one embodiment, each CNN has at least one convolutional layer. In at least one preferred embodiment, each CNN has at least two convolutional layers. As discussed bellow, each CNN is trained to execute specific tasks of the module that particular CNN belongs to, and is therefore narrowly focused and trained to perform specific tasks.

In at least one embodiment, the neural network may be the ViT-based model. The ViT-based model is a visual model based on the architecture of a transformer originally designed for text-based tasks. The ViT-based model represents an input scene image 115 as a plurality of scene image patches. The ViT-based model is configured to directly predict class labels for the input scene image 115. In at least one embodiment, the at least one neural network may be the MLP-based model. The MLP-based model is a feedforward neural network having fully connected neurons with nonlinear activation functions, organized in layers. The MLP-based model is configured to distinguish data that is not linearly separable. The one or more neural networks may be also a hybrid model combining elements of CNN models and/or ViT-based models and/or MLP-based models. For instance, the hybrid model may use a CNN for early visual processing (such as, for example, feature extraction), the MLP-based model for dense decision-making, and the ViT-based model for global context. Each of the model types may be pre-trained on large-scale image datasets and fine-tuned for domain-specific segmentation tasks.

In some embodiments, for example, the first neural network may be the first CNN having at least two convolutional layers, the first ViT-based model, the first MLP-based model, a first autoencoder-based model, a first contrastive learning model, a first generative model including but not limited to a generative adversarial network (GAN) or a diffusion-based model, or the first hybrid model comprising at least two of (components of two of, or at least two components of): elements of the first CNN model, elements of the first ViT-based model, elements of the first MLP-based model, elements of the first autoencoder-based model, elements of the first contrastive learning model, and elements of the first generative model. For example, the at least one first neural network may be selected from the group consisting of these models. Similarly, the second neural network for execution of another routine may be also any one of: CNN having at least two convolutional layers, the ViT-based model, the MLP-based model, a autoencoder-based model, a contrastive learning model, a generative model including but not limited to a generative adversarial network (GAN) or a diffusion-based model, or a first hybrid model comprising at least two of (components of two of or at least two components of): elements of the CNN model, elements of the ViT-based model, elements of the MLP-based model, elements of the autoencoder-based model, elements of the contrastive learning model, and elements of the generative model.

In at least one embodiment, the neural networks used for execution of different routines described herein are different models having different architecture from each other. The models may be of the same type (for example, CNN-type) but having different architecture from each other. The neural networks may be both CNNs but have different architecture. For example, and without limitation, the CNNs with different architectures may be YOLO and Faster R-CNN: YOLO treats object detection as a regression problem which directly predicts class probabilities and bounding boxes in a single pass through the network, while Faster R-CNN proposes regions likely to contain objects using a Region Proposal Network (RPN) then classifies those regions and refines bounding boxes. Similarly, the first neural network and the second neural network may be both MLP-based models but with different architectures.

Each one of the object classification routine 201, the grouping routine 321, the comparison routine 331, data adaptation routine 361 and the automated learning routine 341 may be executed using models having different architectures, each model having at least one neural network being a convolutional neural network (CNN) having at least two convolutional layers, a vision transformer-based (ViT-based) model, a multilayer perceptron-based (MLP-based) model, a autoencoder-based model, a contrastive learning model, a generative model, or a hybrid model comprising at least two of: elements of the CNN model, elements of the VIT-based model, elements of the MLP-based model, elements of the autoencoder-based model, elements of the contrastive learning model, and elements of the generative model.

A data group (which may be also referred to as a “cluster”) is generated herein by generating logical links between data elements. To generate the data group, various methods may be used, such as, for example, and not limited to: K-Means, K-medoids, hierarchical grouping, Density-Based Spatial Clustering of Applications with Noise (DBScan), Mean Shift, Gaussian Mixture Models and OPTICS.

Periodically, and on an ongoing basis (for example, every 10 minutes up to monthly), the system 100 as described herein runs a flow analysis routine 380 (also referred to herein as “performance evaluation routine 380”) which implements the steps of the method 200, 300 illustrated in FIGS. 2 and 3, following an object classification process 201. In at least one embodiment, the system 100 and the method 200, 300 as described herein permit evaluating the quality of detection of objects 105. The system 100 and the method 300 are configured to assess automatically (in other words, without relying on human intervention) real-time effectiveness of the object classification process 201 deployed in an object processing facility. The performance evaluation routine may be configured to assess automatically the real-time effectiveness of the object classification process 201 deployed in an object processing facility. For example, the object processing facility may be a sorting facility, for example, and without limitation to, a recycling facility or a construction material sorting facility. The objects 105 may be immobilized or moving, on a conveyor, in a liquid or moving vertically (falling) while being analysed by the system 100 and methods 200, 300 as described herein.

In at least one embodiment, to evaluate and analyze the status of detection while sorting the objects 105, algorithmic methods determining performance metrics (which may be also referred to as “quality control metrics”) are applied to the input scene image 115 (and their accompanying additional sensor data 117, if present). For example, the method 200, 300 as described herein may comprise determining the quantity and/or proportion of unclassifiable and classifiable objects 105 according to the neural network used in sorting, compared to the typical distribution over a comparable period. Alternatively, the rates of the distribution of confidence may be determined and provided by the neural network for each category and/or for each object obtained by the object classification process 201 described below. Grouping of the objects by group (or clusters) and the characteristics of such groupings may be also analyzed during the execution of the flow analysis routine 380 using various methods as described herein.

The object classification process 201 for generating sets of objects that are relevant to model improvement comprises at least two routines, each using at least one neural network, such as, for example, the CNN or ViT-based model or MLP-based model or the hybrid model, for feature extraction, as described above. The method as described herein may also use so-called “transformers” which are a type of neural network architecture that transforms or changes an input sequence into an output sequence. The transformers that are used herein generate the output sequence by learning context and tracking relationships between sequence components. The transformers may implemented when the neural network is a ViT-based model or the MLP-based model.

In at least one embodiment, the following routines (which may be also referred to herein as “models”) may be implemented (executed): a bounding boxes generation routine 121 (bounding boxes generation model 121), a semantic segmentation routine 122 (semantic segmentation model 122), and an object classification routine 123 (object classification model 123).

Referring to FIG. 2, in at least one embodiment, the method 200 comprises execution of an object classification process 201 which comprises execution of an object detection routine 220 (object detection model 220) and execution of the object classification routine 123. The object detection routine 220 may comprise one or more routines: the object detection routine 220 may comprise the bounding boxes generation routine 221; and, in some preferred embodiments, the object detection routine 220 may comprise the semantic segmentation routine 122.

The bounding boxes generation routine 121 (also referred to herein as “detection routine”) receives, as an input, a scene image 115 captured by the camera 110 (the RGB or grayscale camera). The scene image 115 may be merged with additional data from one or more additional sensors 112 (as discussed above). When processing the input scene image 115, the bounding boxes generation routine 121 locates objects 105 in the input scene image 115 by generating the coordinates of (which may be also referred to as “predicting”) bounding boxes 132 around the objects 105 presented in the scene image 115. The term “locating” as used herein comprises identifying that there is an object present, estimating the coordinate of the center of the object, mapping the additional data obtained from the additional sensors related to that particular detected object.

In at least one embodiment, the additional sensor data 117 is used as input to the object detection routine 220. In at least one embodiment, the additional sensor data 117 is used as input to the object classification routine 123. In at least one embodiment, the additional sensor data 117 may be used as input by any routines described herein in order to improve the accuracy of classification.

In at least one embodiment, the bounding boxes generation routine 121 has at least one object detection neural network, which is specifically trained and configured to trace the bounding boxes 132 around the objects 105 on the scene images 115 to produce the cut images 131 (which may be also referred to as “belt images 131” or “bounding boxes images 131”). When executing the machine learning algorithm with the use of the object detection neural network of the bounding boxes generation routine 121 (which may be also referred to as a “detection module”), objects 105 in the input scene image 115 are located (in other words, the location of the objects 105 in the input scene image 115 is determined) by generating the coordinates of the bounding boxes 132 which can be traced around those objects 105. As discussed above, the neural network may be CNN or ViT-based model or MLP-based model or the hybrid model.

Training of the bounding boxes generation routine 121 uses scene images 115 captured by the camera 110 with precise bounding boxes 132 surrounding the objects 105. In at least one embodiment, the bounding boxes 132 for training may be generated automatically based on one or more previous iterations of the bounding boxes generation routine 121. In some embodiments, the system 100 as described herein may request for a human input to annotate training images, in order to receive the annotations for the training images and to generate data (with the bounding boxes 132) for training of the bounding boxes generation routine 121.

As a result of the processing by the bounding boxes generation routine 121, the cut images 131 are generated which have, instead of the scene images 115, the bounding boxes 132 surrounding the objects 105. These bounding boxes images 131 may be merged with and mapped to additional sensor data 117 received from one or more additional sensors 112. The output of the bounding boxes generation routine 121, comprises the bounding boxes images 131 of detected objects 105, in addition to the scene images 115 sent as input, and the coordinates of the bounding boxes 132, also determined by the bounding boxes generation routine 121. In some embodiments, the output of the bounding boxes generation routine 121 may also comprise other information associated with the additional sensor data 117.

In at least one embodiment, the method 200 as described herein comprises executing at least one object detection routine 220 which comprises the bounding boxes generation routine 121 and the semantic segmentation routine 122. In at least one embodiment, the at least one object detection routine 220 is configured to generate detected object locations representing locations of objects 105 based on a scene image 115 received from the camera 110. The bounding boxes generation routine 121 may generate, as its output, bounding boxes images 131 and/or bounding boxes coordinates for each object 105. In other terms, the bounding boxes generation routine 121 is the routine configured to generate detected object locations in the form of bounding boxes 132 surrounding the objects 105.

The semantic segmentation routine 122 is configured to generate detected objects polygons 133 (which may be also referred to as “detected objects masks 133” or “masks 133”) and polygons' coordinates (coordinates of the detected objects polygons 133) representing the objects 105. In other terms, the semantic segmentation routine 122 is a routine configured to generate the detected object locations in the form of polygons 133, delineating their shapes. In at least one embodiment, the detected objects polygons 133 representing the detected objects 105 are generated within the delimitations of the bounding boxes generated by the bounding boxes generation routine 121. The generating of the detected object locations may comprise generating bounding boxes coordinates of the bounding boxes 132 surrounding the objects 105 by the bounding boxes generation routine 121 and, in some embodiments, generating of the polygon coordinates of the detected objects polygons 133 representing the detected objects 105.

The semantic segmentation routine 122 receives, as an input, the data (for example, bounding boxes coordinates) and bounding boxes images 131 or directly scene images 115 received from the bounding boxes generation routine 121 executed previously or received from the camera 110 if the semantic segmentation routine 122 is executed by the object detection routine 220 directly. The semantic segmentation routine 122 generates, as an output, a segmented version of the input scene image 115, referred to herein as a segmented image 125. Each pixel of the segmented image 125 is classified according to the object 105 to which it belongs. The additional data trained, if present, is also predicted.

The scene images 115 and/or the bounding boxes images 131 are fed into the semantic segmentation model 122 in addition to the additional sensor data 117 measured by the additional sensors 112, if they were present at the time of acquisition of the scene images 115. To train the semantic segmentation model 122, images of the objects 105, each with a bounding box 132 around the object 105 (precise contour) contained in the scene image 115 are used. Additional data 117 from the additional sensors 112 present during the acquisition may also be associated with these traced objects 105. Referring to FIGS. 2 and 3, the semantic segmentation routine 122 assigns a class pixel label to each pixel (also referred to as a “class label”) in the region inside the bounding box 132 (so-called “bounding box region”), effectively segmenting objects 105 from an empty bounding box or other nearby objects 105.

The semantic segmentation routine 122 generates detected object locations which may be represented as detected object outlines (shapes) in the form of polygons (which may be also referred to as “detected objects polygons”). The detected object polygons 133 delineate the shape of each object 105. This improves considerably the representation of the real shape of the object 105 and allows to properly target the manipulations (such as, for example, grabbing of the object 105) later.

In at least one embodiment, if two objects 105 (a first object 105a and a second object 105b) are located one over another, the semantic segmentation routine 122 is configured to recognize that the first object 105a overlaps with the second object 105b, and labeling each pixel with the class pixel label permits delineating the whole shapes of both objects 105a, 105b, such that one pixel on one scene image 115 may be related to both the first object 105a and the second object 105b (a series of points related to the outline of the polygon that represents the object 105a, 105b). The semantic segmentation routine 122 may be configured and trained to determine whether two (or more) objects 105 are overlapping with each other. The semantic segmentation routine 122 may be specifically trained to detect the overlap 135 of two or more objects 105 (for example, two objects 105a, 105b) and then to provide representations of the shapes of the objects 105 in the form of polygons 133a, 133b which are very close to real shapes of those objects 105.

In at least one embodiment, the semantic segmentation routine 122 comprises its proper at least one segmentation-oriented CNN. The segmentation-oriented CNN used by the semantic segmentation routine 122 becomes significantly advanced when trained to determine the overlaps of the objects while being focused on the tasks of segmentation. Such segmentation-oriented CNN generates the segmented images that have better quality compared to the representation of the objects that could be generated using the general CNN discussed above.

In at least one embodiment, the semantic segmentation routine 122 may be implemented by the ViT-based model, the MLP-based model, and/or the hybrid model. The ViT-based model may utilize a transformer architecture adapted for visual tasks, in which input image data is divided into patches and embedded for sequential processing using self-attention mechanisms to generate segmentation maps. The MLP-based model may employ a sequence of fully connected layers to learn hierarchical feature representations for pixel-wise classification. The hybrid model may incorporate convolutional layers for local feature extraction, followed by MLP and transformer-based components to enhance both spatial resolution and global context understanding. Each of these model types may be pre-trained on large-scale image datasets and fine-tuned for domain-specific segmentation tasks.

The semantic segmentation routine 122 generates, as an output, a segmented version of the input scene image 115, referred to herein as a segmented image 125. Each pixel of the segmented image 125 is classified according to the object 105 to which it belongs. The additional data trained, if present, is also predicted.

The object classification routine 123 receives, as an input, the segmented images 125 with segmented objects 133 from the semantic segmentation routine 122. These segmented images 125 may be merged with the additional sensor data 117 from one or more additional sensors 117 if present at the time of acquisition, as discussed above. Each segmented image 125 is analyzed by the classification routine 123 to determine the object category. To train the object classification model/routine 123, training segmented objects 133 are sorted by category. The classification model/routine 123 may be retrained to re-adjust categories to adjust to customer needs or to improve performance of the model used by the classification routine 123 or the object classification process 201 in general. As an output, the object classification routine 123 generates a classification identification which may comprise category labels 127 assigned to each segmented object 133 (also referred to herein as a “category object label”) on the segmented image 125. In other terms, the object classification model/routine 123 generates segmented and classified object representations.

The routines 121, 122, 123, as described above, form an object classification process 201, in accordance with at least one embodiment of the present disclosure. Still referring to FIG. 2, following the completion of the routines 121, 122, 123 as described above, a set of segmented and classified objects 301 is captured and recorded during a targeted period (also referred to herein as a “pre-determined period”) according to a pre-determined frequency (for example, every 10 minutes up to monthly). In at least one embodiment, the set of segmented and classified objects 301 may be generated by another object classification process 201, different from the one described above and illustrated in FIG. 2.

FIG. 3 illustrates the method 300 which uses an object classification process 201 as described herein or another object classification process 201, different from the one described above and illustrated in FIG. 2, and the results generated by such object classification process 201, in accordance with at least one embodiment. In method 300, the object classification process 201 may comprise routines 121, 122, 123 as illustrated in FIGS. 2 and 3 and described herein, or, alternatively, may comprise other routines that may generate, as an output, the set of segmented and classified objects 301 (also referred to herein as “identified objects 301”) captured during the pre-determined period, and corresponding segmented and classified object images 302 (also referred to herein as “identified object images 302”).

To detect specific objects 105 and to improve the detection of the objects 105, which have been segmented and classified as described (segmented and classified objects 301), for example, above, by the detection routine 121, the segmentation routine 122 and the classification routine 123, the set of segmented and classified objects 301 may be used in addition to a series of pre-annotated and counter-validated images 303. Each one of the pre-annotated and counter-validated images 303 has corresponding additional sensor data 117, if it is available.

A grouping model/routine 321 (which may be referred to as a “grouping model 321” or a “grouping routine 321” in FIG. 1), may be implemented with a software and hardware by a grouping module 321 in FIGS. 2, 3. The grouping routine 321 uses a neural network which is configured to determine groupings of objects (the “data group” discussed above) using one of the techniques described above.

In at least one embodiment, the grouping routine 321 comprises at least one neural network. The neural network may be the CNN, each one CNN having at least two convolutional layers. In at least one embodiment, the grouping routine 321 comprises at least one neural network which is a CNN having at least two convolutional layers, a ViT-based model, a MLP-based model or a hybrid model. The hybrid model may have elements of at least two of the CNN, the ViT model, and the MLP-model.

As described above, the neural networks implemented for the grouping routine 321 may be different and may be trained differently from the neural networks implemented for the other routines described herein of method 200, 300.

Training of the grouping routine 321 (and therefore the neural network implemented therein) comprises using a large set of data representing manually and/or automatically annotated objects as well as their additional data if available. The grouping routine 321 generates, as the output, multiple sequences of grouped objects and corresponding grouped object images 323 (FIG. 3) with comparison factors versus pre-annotated objects 303 to determine objects of interest for unsupervised and/or semi-supervised learning. The grouping routine 321 uses the comparison factors to establish whether the objects 105 of the set of segmented and classified objects 301 have to be grouped together. One or more techniques to establish their similarity may be applied. For example, these techniques may be one of or a combination of: isolation forest, autoencoders, a one-class svm, Siamese networks, triplet networks, locality-sensitive hashing, product quantization, or a Graph Neural Networks (GNN).

In at least one embodiment, the grouping routine 321 is implemented using the ViT-based model. In at least one embodiment, the grouping routine 321 is implemented using the MLP-based model. In at least one embodiment, the grouping routine 321 is implemented using a hybrid model having elements of at least two of (components of two of, or at least two components of): the CNN, the ViT-based model, and the MLP-based model. As described above, the grouping routine 321 may be implemented with a neural network which may be, for example: the CNN having at least two convolutional layers, a first vision transformer-based (ViT-based) model, a multilayer perceptron-based (MLP-based) model, a autoencoder-based model, a contrastive learning model, a generative model which may be, for example, a generative adversarial network (GAN) or a diffusion-based model, or a hybrid model comprising at least two of (components of two of, or at least two components of): elements of the CNN model, elements of the ViT-based model, elements of the MLP-based model, elements of the autoencoder-based model, elements of the contrastive learning model, and elements of the generative model.

The grouping routine 321 is configured to group the segmented and classified object images 302 of the corresponding to the set of segmented and classified objects 301 which have been generated by the object classification process 201. The grouping routine 321 is configured to group the object images based on their visual likeness. The grouping routine 321 generates, as an output, the grouped object images 323.

In some embodiments, the object images (corresponding segmented and classified object images 302 which are unvalidated classified objects and pre-annotated and counter-validated images 303 which are an existing set of data) may comprise the additional sensor data 117 captured and generated at the time of acquisition by, and received from the additional sensor devices 112 described above, such as, for example, at least one of: the laser sensor, the volumetric sensor, the point measurement system for visible spectroscopy values, the near infrared (NIR) system, a short-wave infrared (SWIR) system, the middle wavelength infrared (MWIR) system, the sensor data being captured at the time of acquisition, the radiography or fluoroscopy X-ray system, the thermal camera, captured at the time of acquisition, the visible detector, captured at the time of acquisition, invisible marker detector.

Following the generation of the grouped object images 323, the method 300 then evaluates the grouped objects of the grouped object images 323 based on comparison scores by a comparison routine 331.

As described above, the comparison routine 331 may be implemented with another neural network which may be, for example: the CNN having at least two convolutional layers, a first vision transformer-based (ViT-based) model, a multilayer perceptron-based (MLP-based) model, a autoencoder-based model, a contrastive learning model, a generative model which may be, for example, a generative adversarial network (GAN) or a diffusion-based model, or a hybrid model comprising at least two components of: elements of the CNN model, elements of the ViT-based model, elements of the MLP-based model, elements of the autoencoder-based model, elements of the contrastive learning model, and elements of the generative model. As described above, the neural networks used for execution of different routines described herein (such as, for example, the grouping routine 321 or the comparison routine 331) are different models having different architecture from each other.

During the execution of the comparison routine 331, several lists of objects 105 are generated. In at least one embodiment, a list of problematic objects 271 (also referred to as a “problematic objects list 271”) is generated after the execution of the comparison routine 331. The problematic objects 271 are difficult to determine automatically (that is, problematic) and deserve to be addressed in semi-supervised oriented learning. A list of value-added objects 272 (also referred to as a “value-added objects list 272”) may be also generated by the comparison routine 331. The list of value-added objects 272 may be added to a set of objects that can be considered as training candidates in unsupervised machine learning. In at least one embodiment, the comparison routine 331 of the method 200, 300 (which may execute the flow analysis routine 380) also generates a list of new objects 276 (also referred to as a “new objects list 276”). The new objects have little or no immediate comparison in the trained set of objects. Other lists may be generated by the comparison routine 331, and the lists and, in some embodiments, objects of these lists may be determined to be part of objects of interest 335 or object sequences 333.

The comparison routine 331 generates a plurality of object sequences 333, and optionally identifies objects of interest 335 when comparing against pre-annotated objects 303. In at least one embodiment, the objects of interest 335 are matched with a previously annotated object 303 (which was annotated previously for example, by a previous run of the method 300 and/or has been stored in a previously annotated objects database). The objects of interest 335 may be revised by a supervised or by a semi-supervised verification routine and some of the objects of interest 335 may be transmitted to be part of the object sequences 333. Object sequences 333 comprise the objects that are used later for learning/training purposes. Object sequences 333 have been grouped by previously executed routines of method 300.

An automated learning routine 341 then conducts an unsupervised and/or semi-supervised learning tasks by using the plurality of object sequences 333 generated by the comparison routine 331.

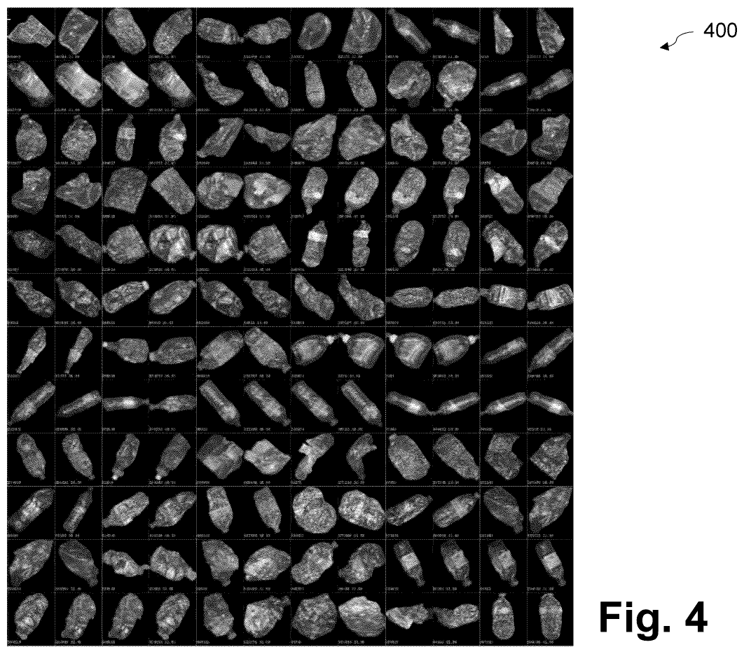

The following processes (sub-routines) may be implemented in the automated learning routine 341. FIGS. 4-7 illustrate examples of objects obtained at different stages of implementation of the method illustrated in FIGS. 2 and 3, in accordance with at least one embodiment of the present disclosure.

In at least one embodiment, following the data adaptation 361, input data to learning routine 370 is generated. The input data for learning routine 370 may comprise, for example, value-added objects 372, poorly characterized objects 421, and unmatched objects 621. In at least one embodiment, the system 100 is configured to determine value-added objects 372 (also referred to herein as “learning routine value-added objects 372”) and use them in the learning routine for unsupervised machine learning using an automatically executed process, which may be also referred to as an “unsupervised learning sub-routine 351”. The unsupervised learning sub-routine 351 is configured to match, with another pre-annotated object, each object of the set of segmented and classified objects 301 that, as a result of the previous steps, is close to pre-determined minimum confidence thresholds for detection, classification and/or segmentation. The matching is based on a similarity score generated by the neural network of the grouping routine 321 within each group (cluster). Each group of the grouped objects is assigned a category of the pre-annotated object 303 (in other words, the category assigned to the group of the grouped object images 323 corresponds to the category of the pre-annotated object), thus improving learning. FIG. 4 illustrates non-limiting examples of such objects of one group of the grouped object images 323. Each object image may comprise an object label according to the current characterization of the object within the method 300.

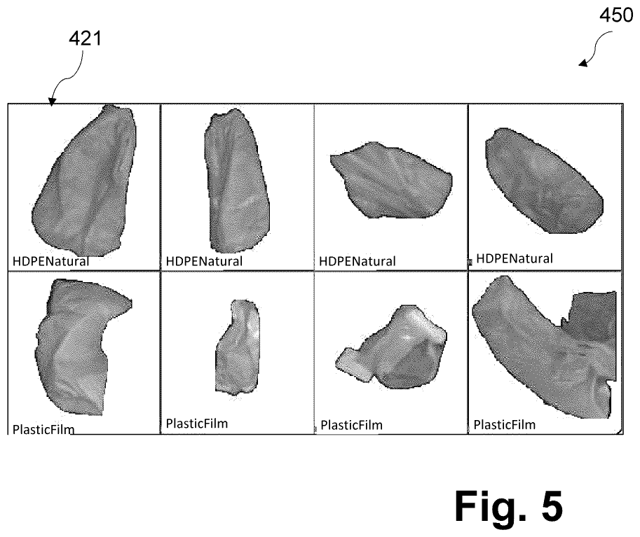

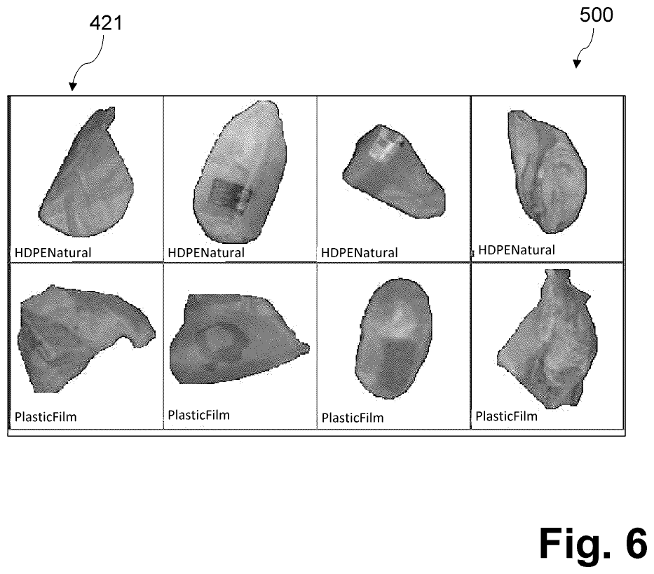

In at least one embodiment, the system 100 determines poorly characterized abnormalities for semi-supervised learning using another process, which may be also referred to as a “semi-supervised learning sub-routine 352”, which may be part of the automated learning routine 341. The semi-supervised learning sub-routine 352 is configured to use (in some embodiments, after identifying) poorly characterized objects 421 (also referred to herein as “learning routine characterized objects 421”) which are determined to be near or below the pre-determined confidence thresholds (whether in detection, segmentation, or classification). The similarity factor in the semi-supervised learning sub-routine 352 may yield a high similarity score with pre-annotated objects that are classified under a different category than the category inferred by the object classification routine 123. The poorly characterized objects 421 may be prepared and prioritized for supervised review (by a user, for example), before adding them to the server via the network or correcting existing annotations of the object images. For example, to prepare the poorly characterized objects 421 and their images for a supervised review, the system 100 generates at least one supervised-review image illustrating such poorly characterized object 421, and displays the supervised-review images on the display 160. FIGS. 5 and 6 illustrate examples of such poorly characterized objects 421 in the supervised-review images. As illustrated in FIG. 3, the method 300 may determine and the learning routine 341 may use for learning other lists as well, which may have, for example, other thresholds of characterization (other characterization categories) and representing various levels of certainty in characterization of the objects. Such additional learning lists may be also used in learning.

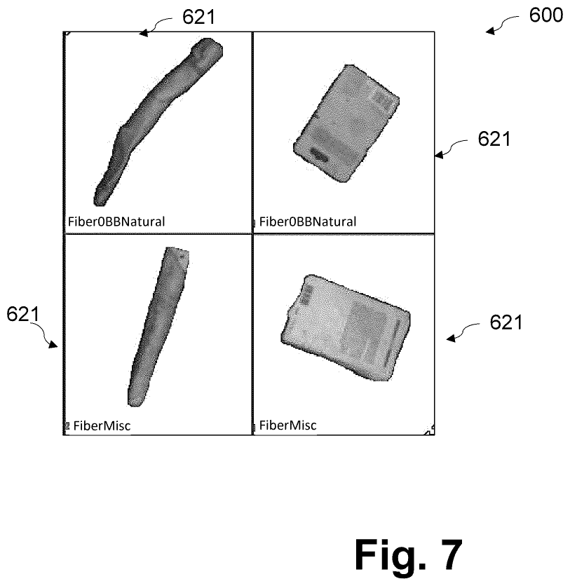

In at least one embodiment, the system 100 detects novelty by a process which is configured to list unmatched objects 621 (also referred to herein “learning routine unmatched objects 621”) which do not have similar (matched) pre-annotated objects 303, which was determined with a high probability using one of the processing techniques (such as unsupervised learning sub-routine 351 or semi-supervised learning sub-routine 352) of the automated learning routine 341 as described above. The listed unmatched objects 621 are then used as candidates for semi-supervised learning. FIG. 7 illustrates a non-limiting example image 600 with such unmatched objects 621 that may be displayed on the display 160.

The final result 250 may be then displayed on the display 160. In at least one embodiment, the final result 250 may comprise different illustrations of the various objects such as, for example, those illustrated in FIGS. 4-7: grouped objects of the of the grouped object images 400 (FIG. 4), poorly characterized objects 421 (FIGS. 5 and 6), and unmatched objects 621 (FIG. 7). The final classified objects are generated after execution of the automated learning routine 341 are part of the final results 250. Each object image may have an object label, which may identify the material and/or object itself, according to the current characterization of the object within the method 300. For example, the object label may be “HDPENatural” or “PlasticFilm”, as illustrated in FIG. 5.

In at least one embodiment, the output of the method 300 and part of the final results 250 are the modified neural networks or new neural networks, that can be used for future classification executed by the object classification process 201. For example, the modified neural networks or new neural networks may be the neural networks used in the object detection routine 220, semantic segmentation routine 122, the classification routine 123 of the object classification process 201, as well as grouping routine 321, comparison routine 331, data adaptation routine 361 and/or learning routine 341. In at least one embodiment, the method 300 (flow analysis routine 380) generates final results 250 that comprise generating at least one new neural network that may be used, for example, as neural network(s) in object classification process 201, grouping routine 321, comparison routine 331, data adaptation routine 361, learning routine 341 or other routines of the method 300. In some embodiments, the new neural network generated by the method 300 may be used in other systems and methods.

In addition, the databases, such as, for example, the database having pre-annotated and counter-validated images 303 and the databases used by the object classification process 201 (for example, but not limited, for classification) may be also modified as a result of execution of the method 300. The value-added objects 372, poorly characterized objects 421, unmatched objects 621 may be used for neural networks learning. Results of the analysis of grouping may be also part of the final results 250.

In at least one embodiment, prior to executing, by the automated learning routine 341, unsupervised and semi-supervised learning tasks, a data adaptation routine 361 is executed. The data adaptation routine 361 may be executed using at least one of the following methods: entropy minimization, contrastive learning for Test Time Adaptation (TTA), batch normalization adaptation, adaptive data augmentation, and transfer learning and fine tuning. The data adaptation routine 361 is configured to adapt the neural network (implemented by the CNN, ViT-based model, MLP-based model or the hybrid model) to new target environments). For example, the new target environment may be exterior setting (environment) compared to the interior setting. This may include, for example, adapting the old images to approach the new images in one or more adaptation characteristics (for example, and without limitation, in lighting, such as, for example, in the exterior setting versus the interior setting) taken in the new environment.

Entropy minimalization may be used to encourage the model to make confident predictions on unlabeled target domain data (the target domain being the new target environment) by minimizing the entropy of the output probability distribution. Contrastive learning learns to group similar representations (same class) together and push dissimilar ones apart, even in the absence of labels. In TTA, augmentations of the same test sample can be treated as positives. Batch normalization updates the running mean and variance of batchnorm layers using test data without changing the weights. Adaptative data augmentation modifies the data augmentation strategies based on model feedback or test-time performance. It ensures that augmentations remain meaningful under distribution shift. Transfer learning and fine tuning leverages one of our trained model and adapts it to a new domain by training on the target dataset.

In at least one embodiment, the final results 250 and other output of the method 300 such as, for example, classification results generated by the method 300 (for example, input data for the learning routine 370, such as the learning routine value-added objects 372, etc.) generated by the system 100 and method 200, 300 described herein may be used to generate breakdown statistics of the objects 105. For example, the system 100 may determine and generate the indication of the quantity of particular materials from which the objects 105 are made. The final results 250 may be further used to estimate weight and/or dimensions (and, for example, area used) of the classified objects.

Based on the final results 250 and other output of the method 300, the system 100 as described herein may generate and transmit instructions to perform a mechanical sorting operation on each one of the final classified objects generated by the system 100 after executing the learning routine 341 or on a subset of the classified objects. The mechanical sorting operation may involve, for example, and without limitation, manipulation of a robotic arm, air nozzle activation, operation of a flip gate, etc. In a non-limiting example, the robotic arm may receive the instructions comprising actions to perform (for example, move), and the classification, as well as the coordinates of the object with the object polygon that was determined by the segmentation model 122.

In some embodiments, the final result 250 and other output of the method 300, such as, for example, classification results generated by the method 300 (for example, the learning routine value-added objects 372, etc.), may be transmitted to and used as an input and instructions in other systems to adjust operation of the other systems within the object processing facility, such as, for example, the sorting facility. In some embodiments, the classification results may be further used in and/or to generate instructions transmitted to a targeting system to instruct the targeting system with regards to manipulation of the targeting system, which may help to target the classified object before manipulation. For example, such targeting systems may use lasers to target the objects 105.

The computer-implemented method is described herein configured to execute the routines as described herein. In at least one embodiment, there is provided herein a computer program comprising instructions which, when the program is executed by a computer, cause the computer to carry out the methods 200, 300 as described herein. The system and method as described herein may, by implementation of the performance evaluation routine, help to automatically assess, a real-time effectiveness of an object classification process deployed in an object processing facility, where the object classification process uses scene images of objects to generate object images.

In at least one embodiment, the method 200, 300 as described herein comprises: receiving, from an object classification process 201 using scene images 115 of objects 105 in an object processing facility, a set of segmented and classified objects 301 captured during a pre-determined period; grouping the object images of the segmented and classified objects 302 by a grouping routine 321 based on their visual likeness to generate grouped object images 323, the grouping routine 323 comprising at least one neural network; evaluating the objects of the object images based on comparison scores by a comparison routine 331, and generating a plurality of object sequences 333; and executing, by an automated learning routine, unsupervised and semi-supervised learning tasks by using the plurality of object sequences 333 to generate a final result 250.

In at least one embodiment, the system 100 as described herein comprises: a camera 110 configured to capture initial object images of objects 105; a display 160; and a processor 150 configured to: receive, from an object classification process 321 using scene images 115 of objects 105 (for example, in an object processing facility), a set of segmented and classified objects captured during a pre-determined period; group the object images of the segmented and classified objects 301 by a grouping routine based on their visual likeness to generate grouped object images 323, the grouping routine 321 comprising at least one neural network; evaluate the objects 105 of the object images based on comparison scores by a comparison routine 331, and generating a plurality of object sequences 333; and execute, by an automated learning routine 341, unsupervised and semi-supervised learning tasks by using the plurality of object sequences 333 to generate a final result 250.

In at least one embodiment, the method may comprise: generating, by an object detection routine comprising at least one first convolutional layer deep learning network, belt images of objects located on a scene image, based on the scene image received from a camera and an additional data received from additional sensors, the belt images having a plurality of bounding boxes; assigning a class label to each pixel of each bounding box by a semantic segmentation routine comprising at least one second convolutional layer deep learning network, and generating a segmented image classified according to the object to which it belongs; generating a set of segmented and classified objects captured during a pre-determined period by an object classification routine comprising at least one third convolutional layer deep learning network; and grouping the objects, by a grouping routine comprising at least one fourth convolutional layer deep learning network, to generate multiple sequences of objects with comparison factors versus pre-annotated objects to determine objects of interest for at least one of unsupervised learning by unsupervised learning sub-routine and semi-supervised learning by semi-supervised learning sub-routine.

While preferred embodiments have been described above and illustrated in the accompanying drawings, it will be evident to those skilled in the art that modifications may be made without departing from this disclosure. Such modifications are considered as possible variants comprised in the scope of the disclosure.

1. A method comprising:
receiving, from an object classification process using scene images of objects in an object processing facility, a set of segmented and classified objects captured during a pre-determined period;
grouping the object images of the segmented and classified objects by a grouping routine based on their visual likeness to generate grouped object images, the grouping routine comprising at least one neural network;
evaluating the objects of the object images based on comparison scores by a comparison routine, and generating a plurality of object sequences; and
executing, by an automated learning routine, unsupervised and semi-supervised learning tasks by using the plurality of object sequences to generate a final result.

2. The method of claim 1, further comprising, prior to executing the automated learning routine, adapting the plurality of object sequences to new target environments using a data adaptation routine to generate adapted object sequences and using the plurality of adapted object sequences by the automated learning routine when executing unsupervised and semi-supervised learning tasks.

3. The method of claim 1, wherein the data adaptation routine is executed by entropy minimization, contrastive learning for Test Time Adaptation (TTA), batch normalization adaptation, adaptive data augmentation, or a transfer learning and fine tuning.

4. The method of claim 1, wherein the at least one neural network is a convolutional neural network (CNN) having at least two convolutional layers, a vision transformer based (ViT-based) model, a multi layer perceptron based (MLP-based) model, or a hybrid model comprising at least two of: elements of the CNN model, elements of the VIT-based model, and elements of the MLP-based model.

5. The method of claim 1, wherein the at least one neural network is a convolutional neural network (CNN) having at least two convolutional layers, a vision transformer-based (ViT-based) model, a multilayer perceptron-based (MLP-based) model, a autoencoder-based model, a contrastive learning model, a generative model, or a hybrid model comprising at least two of: elements of the CNN model, elements of the ViT-based model, elements of the MLP-based model, elements of the autoencoder-based model, elements of the contrastive learning model, and elements of the generative model.

6. The method of claim 1, further comprising identifying objects of interest when comparing against pre-annotated objects after generating the plurality of object sequences.

7. The method of claim 1, further comprising learning the object classification process using the final results to modify neural networks of the object classification process.

8. The method of claim 1, wherein each one of the object classification routine, the grouping routine, the comparison routine, and the automated learning routine are executed using models having different architectures, each model having at least one neural network being a convolutional neural network (CNN) having at least two convolutional layers, a vision transformer-based (ViT-based) model, a multilayer perceptron-based (MLP-based) model, a autoencoder-based model, a contrastive learning model, a generative model, or a hybrid model comprising at least two of: elements of the CNN model, elements of the ViT-based model, elements of the MLP-based model, elements of the autoencoder-based model, elements of the contrastive learning model, and elements of the generative model.

9. The method of claim 1, wherein sensor data is captured and generated at the time of acquisition of the scene images, the sensor data being received from at least one additional sensor and used as input to the object classification process.

10. The method of claim 9, wherein the at least one additional sensor is at least one of a laser sensor, a volumetric sensor, a point measurement system for visible spectroscopy, a near infrared (NIR) system, a short-wave infrared (SWIR) system, a middle wavelength infrared (MWIR) system, a radiography or fluoroscopy X-ray system, a thermal camera, a visible detector, and an invisible detector.

11. A system comprising:
a camera configured to capture initial object images of objects;
a display; and
a processor configured to:
receive, from an object classification process using scene images of objects in an object processing facility, a set of segmented and classified objects captured during a pre-determined period;
group the object images of the segmented and classified objects by a grouping routine based on their visual likeness to generate grouped object images, the grouping routine comprising at least one neural network;
evaluate the objects of the object images based on comparison scores by a comparison routine, and generating a plurality of object sequences; and
execute, by an automated learning routine, unsupervised and semi-supervised learning tasks by using the plurality of object sequences to generate a final result.

12. The system of claim 11, wherein the processor is further configured to identify objects of interest when comparing against pre-annotated objects.

13. The system of claim 11, further comprising a sensor generating sensor data at the time of acquisition of the object images, the sensor data being used as input for the object classification process.

14. The system of claim 13, wherein the at least one additional sensor is at least one of a laser sensor, a volumetric sensor, a point measurement system for visible spectroscopy, a near infrared (NIR) system, a short-wave infrared (SWIR) system, a middle wavelength infrared (MWIR) system, a radiography or fluoroscopy X-ray system, a thermal camera, a visible detector, and an invisible detector.

15. The system of claim 11, wherein the processor is further configured to, prior to executing the automated learning routine, adapt the plurality of object sequences to new target environments using a data adaptation routine to generate adapted object sequences and use the plurality of adapted object sequences by the automated learning routine when executing unsupervised and semi-supervised learning tasks.

16. The system according to claim 11, wherein the data adaptation routine is executed by entropy minimization, contrastive learning for Test Time Adaptation (TTA), batch normalization adaptation, adaptive data augmentation, or a transfer learning and fine tuning.

17. The system of any one of claim 11, wherein at least one neural network is a convolutional neural network (CNN) having at least two convolutional layers, a vision transformer based (ViT-based) model, a multi layer perceptron based (MLP-based) model, or a hybrid model comprising at least two of: elements of the CNN model, elements of the ViT-based model, and elements of the MLP-based model.

18. The system of claim 11, wherein the at least one neural network is a convolutional neural network (CNN) having at least two convolutional layers, a vision transformer-based (ViT-based) model, a multilayer perceptron-based (MLP-based) model, a autoencoder-based model, a contrastive learning model, a generative model, or a hybrid model comprising at least two of: elements of the CNN model, elements of the ViT-based model, elements of the MLP-based model, elements of the autoencoder-based model, elements of the contrastive learning model, and elements of the generative model.

19. The system of claim 11, wherein each one of the object classification routine, the grouping routine, the comparison routine, and the automated learning routine are executed using models having different architectures, each model having at least one neural network being: a convolutional neural network (CNN) having at least two convolutional layers, a vision transformer-based (ViT-based) model, a multilayer perceptron-based (MLP-based) model, a autoencoder-based model, a contrastive learning model, a generative model, or a hybrid model comprising at least two of: elements of the CNN model, elements of the ViT-based model, elements of the MLP-based model, elements of the autoencoder-based model, elements of the contrastive learning model, and elements of the generative model.

20. The system of claim 11, wherein the processor is configured, by the automated learning routine, to modify neural networks of the object classification process.
